(19) United States
(12) Patent Application Publication
(10) Pub. No.: US 2022/0267564 A1
(43) Pub. Date: Aug. 25, 2022

(54) THERMOPLASTIC RESIN FILM, AND METHOD FOR PRODUCING SAME

(71) Applicant: YUPO CORPORATION, Tokyo (JP)

(72) Inventors: Ryota TOYAMA, Ibaraki (JP); Hiroshi KOIKE, Ibaraki (JP); Yutaro SUGAMATA, Ibaraki (JP)

(73) Assignee: YUPO CORPORATION, Tokyo (JP)

(21) Appl. No.: 17/630,715

(22) PCT Filed: Jul. 29, 2020
(86) PCT No.: PCT/JP2020/028970

§ 371 Date: Jan. 27, 2022

(30) Foreign Application Priority Data
Jul. 31, 2019 (JP) 2019-141778

(51) Int. Cl. C08K 3/26

(52) U.S. Cl. CPC C08K 3/26; C08K 2003/265

(57) ABSTRACT

To suppress a decrease over time in the adhesion of ink to a thermoplastic resin film, provided is a thermoplastic resin film containing an inorganic filler, wherein at least one surface of the thermoplastic resin film satisfies the following formula (1) and formula (2):

0.8≤S1/S0≤1.0 (1)

3.0≤S0 (2)
wherein S0 represents an oxygen atom concentration (atm %) before a washing treatment (A) is carried out, S1 represents the oxygen atom concentration (atm %) after the washing treatment (A) is carried out, the oxygen atom concentration is a ratio of the number of oxygen atoms to a sum of the number of oxygen atoms and the number of carbon atoms measured by XPS (X-ray photoelectron spectroscopy) (number of oxygen atoms/(number of oxygen atoms+number of carbon atoms)), and the washing treatment (A) is a washing treatment carried out using distilled water.

### TECHNICAL FIELD

The present invention relates to a thermoplastic resin film and a method for producing the same.

### BACKGROUND ART

Conventionally, thermoplastic resin films have been used as a printing paper having excellent water resistance and durability. It is known that adhesion with the ink used in printing is improved by subjecting the surface of thermoplastic resin film to an oxidation treatment. For example, in order to facilitate processes such as printing or coating, polypropylene pearl gloss synthetic paper that has been subjected to a corona treatment by a high-frequency discharge apparatus has been proposed (see Patent Literature 1).

### CITATION LIST

### Patent Literature

Patent Literature 1: Japanese Patent Laid-Open No. 2000-211008

### SUMMARY OF INVENTION

### Technical Problem

As a method for further enhancing the adhesion between the ink and the thermoplastic resin film that is a recording material, an oxidation treatment using an inert gas is known, but there is a high burden in terms of equipment and a possibility of leakage of the purging gas. Further, there is also a method of further enhancing the adhesion of the ink that is based on an anchor effect besides oxidation treatment, obtained by performing an oxidation treatment on a film surface having undulations formed thereon by means of blending an inorganic filler. Although a film obtained in such a way has high ink adhesion immediately after the oxidation treatment, there is room for improvement in regard to the ink adhesion when stored for a long time.

In recent years, on-demand printing has been increasing in order to support a wide variety of printing in small quantities. In particular, printing using UV ink, especially UV flexographic printing, UV inkjet printing, and the like, which can easily handle small lots, is increasing. Since the ink used in these printing methods has a low viscosity and high polarity, the adhesion of the ink to the recording material tends to decrease over time.

An object of the present invention is to suppress a decrease over time in adhesion of ink to a thermoplastic resin film.

### Solution to Problem

As a result of diligent investigation by the present inventors to achieve the above object, it was found that the above object can be achieved by a thermoplastic resin film that has a surface having an oxygen atom concentration of a certain value or more and in which there is little change in the oxygen atom concentration even after a washing treatment with distilled water, thereby completing the present invention.

That is, the present invention is as follows.

[1] A thermoplastic resin film comprising an inorganic filler, wherein

at least one surface of the thermoplastic resin film satisfies the following formula (1) and formula (2):

0.8≤S1/S0≤1.0 (1)

3.0≤S0 (2)

wherein S0 represents an oxygen atom concentration (atm %) before a washing treatment (A) is carried out, S1 represents the oxygen atom concentration (atm %) after the washing treatment (A) is carried out, the oxygen atom concentration is a ratio of the number of oxygen atoms to a sum of the number of oxygen atoms and the number of carbon atoms measured by XPS (X-ray photoelectron spectroscopy) (number of oxygen atoms/(number of oxygen atoms+number of carbon atoms)), and the washing treatment (A) is a washing treatment carried out using distilled water.

[2] The thermoplastic resin film according to [1], wherein

a content of the inorganic filler in the thermoplastic resin film is 1 to 70% by mass.

[3] The thermoplastic resin film according to [1] or [2], wherein

the inorganic filler has an average particle size of 0.1 to 10 μm.

[4] The thermoplastic resin film according to any of [1] to [3], wherein the thermoplastic resin film has a porosity of 3 to 600.
[5] The thermoplastic resin film according to any of [1] to [4], wherein

the thermoplastic resin film has a multilayer structure, at least an outermost layer on one side is an inorganic filler-containing layer containing a thermoplastic resin and an inorganic filler, and the surface of the outermost layer satisfies the formula (1) and the formula (2).

[6] A method for producing a thermoplastic resin film, comprising:

a step of subjecting at least one surface of a film containing a thermoplastic resin and an inorganic filler to an oxidation treatment; and

a step of carrying out a washing treatment (B) on the surface subjected to the oxidation treatment,
wherein the surface on which the washing treatment (B) has been carried out satisfies the following formula (1) and formula (2):

0.8≤S1/S0≤1.0 (1)

3.0≤S0 (2)

wherein S0 represents an oxygen atom concentration (atm %) before a washing treatment (A) is carried out, S1 represents the oxygen atom concentration (atm %) after the washing treatment (A) is carried out, the oxygen atom concentration is a ratio of the number of oxygen atoms to a sum of the number of oxygen atoms and the number of carbon atoms measured by XPS (X-ray photoelectron spectroscopy) (number of oxygen atoms/(number of oxygen atoms+number of carbon atoms)), and the washing treatment (A) is a washing treatment carried out using distilled water.

[7] The method for producing a thermoplastic resin film according to [6], wherein

the oxidation treatment is atmospheric dielectric barrier discharge treatment.

[8] The method for producing a thermoplastic resin film according to [6] or [7], wherein

the washing treatment (B) includes a washing treatment carried out using water or an aqueous solution having a pH of 5 to 11.

### Advantageous Effects of Invention

According to the present invention, a decrease over time in the adhesion of ink to a thermoplastic resin film can be suppressed.

### BRIEF DESCRIPTION OF DRAWINGS

FIG. 1 is a cross-sectional view illustrating a structural example of a thermoplastic resin film of an embodiment.

FIG. 2 is a conceptual diagram illustrating an example of the steps for producing the thermoplastic resin film.

FIG. 3 is an upper view illustrating a printing face of the thermoplastic resin film of the example and comparative examples when ink adhesion is evaluated.

### DESCRIPTION OF EMBODIMENT

Hereinafter, the thermoplastic resin film of the present invention and production method thereof will now be described in detail. However, the description of the constituent elements described below is an example (representative example) of one embodiment of the present invention, and the present invention is not specific to the subject matter of that description. Further, the dimension ratios in the drawings are not limited to the shown ratios.

In this specification, the term “(meth)acrylic” refers to both acryl and methacryl.

### (Thermoplastic Resin Film)

The thermoplastic resin film of the present invention contains an inorganic filler, in which at least one surface of the thermoplastic resin film satisfies the following formula (1) and formula (2):

0.8≤S1/S0≤1.0 (1)

3.0≤S0 (2)

wherein S0 represents an oxygen atom concentration (atm %) before a washing treatment (A) is carried out, S1 represents the oxygen atom concentration (atm %) after the washing treatment (A) is carried out, the oxygen atom concentration is a ratio of the number of oxygen atoms to a sum of the number of oxygen atoms and the number of carbon atoms measured by X-ray photoelectron spectroscopy (XPS) (number of oxygen atoms/(number of oxygen atoms+number of carbon atoms)), and the washing treatment (A) is a washing treatment carried out using distilled water.

### <XPS Measurement Method>

The oxygen atom concentrations S0 and S1 measured by XPS can be determined from the ratio between values obtained by multiplying the relative sensitivity of each peak by the peak intensity area of the O1s and C1s, respectively (e.g., see “Ko-bunshi Hyomen no Kiso to Ouyou (jou)” (corresponding to “Basic and Applied Polymer Surfaces (Part 1)” in Japanese), edited by Yoshito Ikada, published by Kagaku-Dojin, 1986, Chapter 4).

The surface of a thermoplastic resin film containing an inorganic filler has a high adhesion with ink due to an anchor effect. Further, thermoplastic resin films having a high oxygen atom concentration on the surface and high ink adhesion have a high S0 value, that is, satisfy formula (2). The S0 value reflects the total amount of oxygen atoms included in both the oxygen-containing functional groups bonded to the film surface and the oxygen atom-containing foreign matter present on the film surface. On the other hand, formula (1) represents, when a washing treatment (A) is carried out on the film surface, the change in oxygen concentration on the film surface before and after that washing treatment (A). When the value of S1/S0 in formula (1) is 0.8 or more and 1.0 or less, this means that the oxygen atom concentration on the film surface does not change significantly before and after the washing treatment (A). That is, the value of S0 in formula (2) represents an oxygen concentration in which the majority of the oxygen atoms are derived from oxygen-containing functional groups, and that there is a low amount of oxygen atom-containing foreign matter. Therefore, there is little decrease in ink adhesion over time, and the thermoplastic resin film is excellent as printing paper.

Here, the “washing treatment (A)” is an operation for measuring the amount of oxygen atom-containing foreign matter present on the thermoplastic resin film surface. The “distilled water” used in the washing treatment (A) is water having a conductivity at 25° C.; of 1.0 μS/cm or less and contains almost no impurities. Examples of the production method include a method of distilling ion-exchange water with a distiller, and distillation may be repeated a plurality of times to increase purity. Commercially available products may be used for the distilled water, examples thereof including Otsuka distilled water for injection (product name, Otsuka Pharmaceutical Factory, Inc.), Distilled Water (product name, Wako Pure Chemical Industries, Ltd.), and the like.

The surface satisfying formulas (1) and (2) can be formed by, in the production steps of the thermoplastic resin film, subjecting the film surface to an oxidation treatment, and then carrying out a washing treatment (B). Here, “washing treatment (B)” is a treatment in the production steps of the thermoplastic resin film, and is a different treatment from the above-described “washing treatment (A)”. The details of the washing treatment (B) will be described later. According to investigation by the present inventors, the oxidation treatment increases the adhesion of the film surface with the ink, and in films where an inorganic filler is present on the surface, the anchor effect further enhances the effect of an improvement in ink adhesion. On the other hand, the resin molecules are cut by the electric discharge during the oxidation treatment, generating a low-molecular-weight acidic compound on the film surface, which tends to reduce the adhesion of the ink to the film surface. Further, it was found that in films having an inorganic filler on the surface, an ionic bond is formed between an inorganic filler on the film surface, and a NOₓ gas component such as NO₂ and NO₃ which exists in plasma under atmospheric discharge, that the amount of foreign matter generated on the surface is larger than for films not containing an inorganic filler, and therefore the tendency for a decrease in adhesion of the ink over time is higher. Although the detailed mechanism is not clear, the present inventors believe that oxygen atom-containing foreign matter, such as low-molecular-weight acidic compounds generated as a byproduct of the oxidation treatment and foreign matter generated due to binding between NOx gases to the inorganic filler, are present between the ink and the film surface, causing a gradual reduction in the adhesion of the ink. The present inventors discovered that by further carrying out the washing treatment (B) after the oxidation treatment to remove byproducts (foreign matter), adhesion with the ink can be maintained for a long time. Moreover, it can be considered that the smaller the ratio (S1/S0) between the oxygen atom concentrations before and after the washing treatment (A) is, the larger the ratio of such oxygen atom-containing foreign matter is.

The thermoplastic resin film of the present invention is a film molded body of a resin composition containing a thermoplastic resin and an inorganic filler, and more specifically, it is a single-layer or multilayer film having at least one inorganic filler-containing layer containing a thermoplastic resin and an inorganic filler.

When the thermoplastic resin film has a single-layer structure, the thermoplastic resin film is composed of only the inorganic filler-containing layer, and a surface that satisfies formulas (1) and (2) can be formed by subjecting at least one surface of the inorganic filler-containing layer to an oxidization treatment and then further carrying out the washing treatment (B).

When the thermoplastic resin film has a multilayer structure, at least one of the outermost layers is the inorganic filler-containing layer, and a surface that satisfies formulas (1) and (2) can be formed by subjecting the surface of that outermost layer that is not facing another layer (i.e., one of the outermost surfaces of the thermoplastic resin film) to an oxidization treatment and then further carrying out the washing treatment (B).

Hereinafter, firstly, the components and the like constituting the inorganic filler-containing layer will be described.

### <Thermoplastic Resin>

Examples of the thermoplastic resin include:

polyolefin-type resins such as polyethylene-based resin, polypropylene-based resin, polybutene, or a 4-methyl-1-pentene (co)polymer;

functional group-containing olefin-type resins such as an ethylene-vinyl acetate copolymer, an ethylene-(meth)acrylic acid copolymer, an ethylene-(meth)acrylic acid copolymer metal salt (ionomer), an ethylene-(meth)acrylic acid alkyl ester copolymer (in which the alkyl group preferably has 1 to 8 carbon atoms), or maleate-modified polyethylene, or maleate-modified polypropylene;

polyester-based resins such as an aromatic polyester (polyethylene terephthalate, polybutylene terephthalate, polyethylene naphthalate, etc.) or an aliphatic polyester (polybutylene succinate, polylactic acid, etc.);

polyamide-based resins such as nylon-6, nylon-6,6, nylon-6,10, or nylon-6,12;

styrene-based resins such as syndiotactic polystyrene, atactic polystyrene, an acrylonitrile-styrene (AS) copolymer, a styrene-butadiene (SBR) copolymer, or an acrylonitrile-butadiene-styrene (ABS) copolymer;

a polyvinyl chloride resin;

a polycarbonate resin; and

a polyphenylene sulfide.

Examples of the polyethylene-based resin include low-density polyethylene, medium-density polyethylene, high-density polyethylene, linear low-density polyethylene, a low-crystalline or amorphous ethylene/α-olefin copolymer, or an ethylene-cyclic olefin copolymer.

Examples of the polypropylene-based resin include crystalline polypropylene, low-crystalline polypropylene, amorphous polypropylene, a propylene ethylene copolymer (random copolymer or block copolymer), a propylene/α-olefin copolymer, or a propylene/ethylene/α-olefin copolymer.

The α-olefin is not particularly limited as long as it can be copolymerized with ethylene and propylene. Examples thereof include ethylene, propylene, 1-butene, 1-pentene, 1-hexene, 4-methyl-1-pentene, 1-heptene, or 1-octene, and the like.

Among these thermoplastic resins, a polyolefin-type resin or functional group-containing olefin-type resin having excellent insulation properties and workability is preferred.

One kind of the above-described thermoplastic resins may be selected and used alone, or two or more kinds may be selected and used in combination.

Among the above-described polyolefin-type resins, a polypropylene-based resin is particularly preferred from the viewpoint of workability, water resistance, chemical resistance, cost, and the like. For use of the polypropylene-based resin, from the viewpoint of film moldability, a resin having a lower melting point than a propylene homopolymer is preferably blended in a proportion of 2 to 25% by mass with respect to the total amount of the thermoplastic resin. Examples of such a resin having a lower melting point include a polyethylene-based resin, among which a high-density, medium-density or low-density polyethylene is preferred.

The content of the thermoplastic resin in the inorganic filler-containing layer may be an amount excluding the content of the other components, but from the viewpoint of moldability, the content is preferably 50% by mass or more, more preferably 51% by mass or more, and further preferably 60% by mass.

### <Inorganic Filler>

The inorganic filler roughens by forming undulations (protruding structures) on the film surface. The roughening increases the surface area of the film and can impart an anchor effect. Further, by stretching the inorganic filler-containing substrate, pores (voids) are formed in the film, elastic relaxation is exhibited by the presence of an air layer, and the adhesive strength power of the film surface is improved.

Examples of the inorganic filler include heavy calcium carbonate, light calcium carbonate, calcined clay, silica, diatomaceous earth, white clay, talc, titanium oxide, barium sulfate, silicon oxide, magnesium oxide, alumina, zeolite, mica, sericite, bentonite, sepiolite, vermiculite, dolomite, wollastonite, glass fiber, or inorganic particles obtained by surface-treating these with a fatty acid, a polymer surfactant, and an antistatic agent. Among these, from the viewpoint of pore moldability and cost, calcium heavy carbonate, light calcium carbonate, calcined clay or talc is preferred, and heavy calcium carbonate is more preferred. These may be used singly or in combinations of two or more thereof.

An organic filler may be used in combination with the inorganic filler. When an organic filler is added, organic particles that are incompatible with the thermoplastic resin, which is the main component of the inorganic filler-containing layer, have a higher melting point or glass transition temperature than that of the thermoplastic resin, and that finely disperse under the molten kneading conditions of the thermoplastic resin are preferred. For example, when the thermoplastic resin is a polyolefin-type resin, an organic filler that is a polymer, such as polyethylene terephthalate, polybutylene terephthalate, polycarbonate, nylon-6, nylon-6,6, a cyclic polyolefin, polystyrene, or polymethacrylate, has a higher melting point (e.g., 170 to 300° C.) or a higher glass transition temperature (e.g., 170 to 280° C.) than the melting point of the polyolefin-type resin, and is an incompatible material can be used. These may be used singly or in combinations of two or more thereof.

The average particle size of the inorganic filler and organic filler is, from the viewpoint of the anchor effect and ease of formation of pores, preferably 0.1 μm or more, more preferably 0.3 μm or more, and further preferably 0.5 μm or more. On the other hand, the average particle size of the inorganic filler and the organic filler is, from the viewpoint of improving the durability of the thermoplastic resin film, preferably 10 μm or less, more preferably 5 μm or less, and further preferably 3 μm or less. When the average particle size is 0.1 μm or more, aggregation defects tend to be suppressed, and when the average particle size is 10 μm or less, a decrease in printability and durability due to excessive irregularities tend to be suppressed.

The average particle size when different types of fillers are used together may be a combination of various fillers which individually have a particle size within the above-described range, or may be a combination of various fillers having an average particle size measured with a particle size distribution meter by laser diffraction in a state in which the various fillers are mixed that is within the above-described range.

The average particle size can be determined as the median diameter D₅₀ measured with a particle size distribution meter by laser diffraction.

The content of the inorganic filler in the inorganic filler-containing layer is, from the viewpoint of the anchor effect and pore moldability, preferably 1% by mass or more, and more preferably 5% by mass or more. Further, from the viewpoint of the mechanical strength of the thermoplastic resin film, the content is preferably 70% by mass or less, and more preferably 60% by mass or less. Therefore, the content is preferably 1 to 70% by mass, and more preferably 5 to 60% by mass. A part of the inorganic filler may be replaced with an organic filler to the extent that the effects of the present invention are not impaired.

### <<Porosity>>

When the inorganic filler-containing layer has internal pores, the porosity representing the percentage of pores in the layer is, from the viewpoint of obtaining elastic relaxation due to pore formation, preferably 1% or more, more preferably 3% or more, and further preferably 5% or more. From the viewpoint of maintaining mechanical strength, the porosity is preferably 70% or less, more preferably 60% or less, and further preferably 50% or less.

The method for measuring porosity can be determined from the ratio of the area occupied by pores in a predetermined region of a cross section of the film observed with an electron microscope. Specifically, an arbitrary portion of the film is cut off, and the portion is embedded and solidified in an epoxy resin. Then, the portion is cut perpendicularly to the face direction of the film using a microtome, and affixed to a sample observation stage such that the cut face becomes the face to be observed. Gold, gold-palladium, or the like is vapor-deposited on the face to be observed. The pores are observed with an electron microscope at a magnification facilitating the observation (e.g., magnification of 500 times to 3000 times), and the observed region is captured as image data. The obtained image data is subjected to image processing by an image analyzer, and the porosity can be obtained by calculating the ratio of the area of the pore portion. In this case, the measurement values of 10 or more arbitrary observed locations are averaged to obtain the porosity.

### <Additives>

The inorganic filler-containing layer can optionally contain additives such as a thermal stabilizer (antioxidant), a light stabilizer, a dispersant, or a lubricant. The content of the thermal stabilizer in the thermoplastic resin film is usually 0.001 to 1% by mass. Examples of the thermal stabilizer include stabilizers such as a sterically hindered phenol-based, phosphorus-based, or amine-based stabilizers. The content of the light stabilizer in the inorganic filler-containing layer is usually 0.001 to 1% by mass. Examples of the light stabilizer include sterically hindered amine-based, benzotriazole-based, or benzophenone-based light stabilizers. The dispersant or lubricant can be used for the purpose of dispersing, for example, the inorganic filler or organic filler. The content of the dispersant or lubricant in the inorganic filler-containing layer is usually within the range of 0.01 to 4% by mass. Examples of the dispersant or lubricant include silane coupling agents, higher fatty acids such as oleic acid and stearic acid, polyacrylic acid, polymethacrylic acid, and salts thereof.

### (Thermoplastic Resin Film Having Multilayer Structure)

As described above, the thermoplastic resin film of the present invention may be a single-layer film having only an inorganic filler-containing layer containing the thermoplastic resin and inorganic filler, or may be a multilayered film having the inorganic filler-containing layer as at least one of the outermost layers. In the case of a multilayer structure, each layer can impart a specific function to the thermoplastic resin film. Among such a structure, a thermoplastic resin film having a core layer and a skin layer is preferred from the viewpoint of durability or functionality, and a three-layer structure thermoplastic resin film having a skin layer on either side of the core layer is preferred. In the case of the three-layer structure of skin layer/core layer/skin layer, at least one skin layer is an inorganic filler-containing layer. Of the two surfaces of the inorganic filler-containing layer, the surface that is not facing another layer (i.e., the outermost surface of the thermoplastic resin film) satisfies formulas (1) and (2).

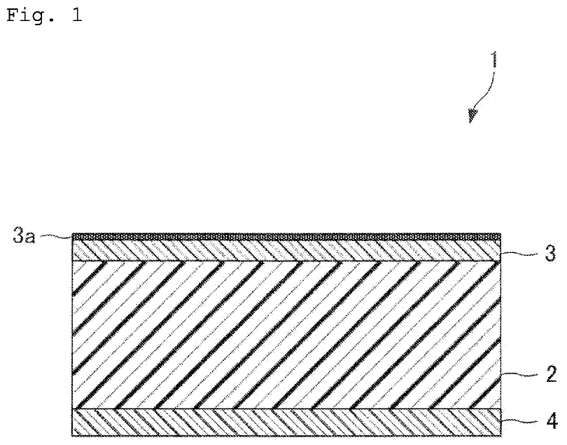

FIG. 1 illustrates, as an embodiment of the present invention, a structural example of a thermoplastic resin film 1 having a three-layer structure.

As shown in FIG. 1, the thermoplastic resin film 1 has a core layer 2 and skin layers 3 and 4 on either side of the core layer 2. The skin layer 3 contains an inorganic filler, and a surface 3a of the skin layer 3 satisfies formulas (1) and (2).

### <Core Layer>

The core layer is preferably a resin film containing a thermoplastic resin. The core layer functions as a support that imparts mechanical strength.

As the thermoplastic resin of the core layer, the above-described thermoplastic resin can be used in the same way. Further, the core layer may or may not contain the inorganic filler described above, but preferably contains the inorganic filler from the viewpoint of adjusting the opacity and the like.

### <Skin Layer>

A skin layer is provided on at least one surface of the core layer, and functions as a protective layer.

As the skin layer, by using an inorganic filler-containing layer that contains the thermoplastic resin and the inorganic filler as described above and that has a surface which satisfies formulas (1) and (2), it is possible to suppress a decrease over time in the adhesion with ink printed on the surface of the skin layer.

As the thermoplastic resin of the skin layer, the various resins listed above as examples of the thermoplastic resin and the inorganic filler included in the inorganic filler-containing layer can be used, and preferred resins are also as described above. When a skin layer is provided on either side of the core layer, the types and contents of the thermoplastic resin and inorganic filler in each skin layer may be the same or different.

The core layer and skin layers may be unstretched films or stretched films. A laminate of the core layer and the skin layer(s) may be a combination of layers of an unstretched film and layers of a stretched film, or a combination of stretched films with the same or different number of stretching axes in each layer. However, it is preferred that at least one layer is stretched from the point of elastic relaxation due to pore formation.

### <Thickness>

The thickness of the core layer is, from the viewpoint of suppressing the occurrence of wrinkles during printing, preferably 20 μm or more, and more preferably 40 μm or more. Further, from the viewpoint of suppressing the decrease in the ability to follow a curved surface due to an increase in the rigidity (stiffness) of the film, the thickness is preferably 300 μm or less, and more preferably 200 μm or less. Therefore, the thickness is preferably 20 to 300 μm, and more preferably 40 to 200 μm.

The thickness of the skin layer is, from the viewpoint of increasing protective performance, preferably 1 μm or more, and more preferably 2 μm or more. Further, since the thickness of the laminate of the core layer and skin layers is preferably 500 μm or less from the viewpoint of reducing the weight of the overall thermoplastic resin film and good handling, in order to adjust to this range, the thickness of the skin layer(s) is preferably 100 μm or less, more preferably 50 μm or less, and further preferably 30 μm or less.

The thickness of a thermoplastic resin film having a single-layer structure can be in the same range as the core layer.

### <Surface Elastic Modulus>

High intermolecular interactions and high adhesion are exhibited between ink and thermoplastic resin films because there is a large correlation between ink adhesion and the elastic modulus of the thermoplastic resin film surface, in which the smaller the elastic modulus is, the better the followability of the ink. Therefore, the surface elastic modulus of the surface satisfying formulas (1) and (2) is preferably 2500 MPa or less, more preferably 2000 MPa or less, and more preferably 1500 MPa or less. From the viewpoint of surface strength, the surface elastic modulus is preferably 10 MPa or more, more preferably 100 MPa or more, and further preferably 200 MPa or more. The surface elastic modulus is measured at a maximum load of 100 μN, and specifically by the method described in the examples.

### <Printing>

On the surface of the thermoplastic resin film of the present invention, a printing layer composed of ink can be formed by printing. When the surface on which the printing layer is formed has an anchor effect due to containing an inorganic filler and satisfies formulas (1) and (2), the decrease over time in adhesion with the ink can be suppressed, and print peeling and the like can be reduced.

The printing method is not particularly limited, and a known printing method such as gravure printing, offset printing, flexographic printing, seal printing, screen printing, dry-type electrophotographic method, wet-type electrophotographic method, a UV-curable inkjet method may be used. Further, according to the printing method, inks such as oily inks, oxidative polymerization curing-type inks, UV-curable inks, water-based inks, or liquid toners (also called electronic inks) may be used. According to the present invention, even when a low-viscosity high-polarity ink, such as a UV-curable ink, is used, a decrease in ink adhesion during long-term storage can be effectively suppressed.

### (Method for Producing a Thermoplastic Resin Film)

When the thermoplastic resin film of the present invention is a single layer, the thermoplastic resin film can be produced by molding a film from a resin composition containing the above-described thermoplastic resin and inorganic filler, subjecting at least one surface to an oxidation treatment, and then carrying out a washing treatment (B). After the washing treatment (B), a drying treatment may be carried out.

To mold the film, various known molding methods can be used. For example, a thermoplastic resin film having a single-layer structure may be produced by melt-kneading a resin composition including the above-described raw materials, extruding the resultant mixture from a single die, and optionally stretching.

When thermoplastic resin film of the present invention has a multilayer structure, the thermoplastic resin film can be produced by forming a laminated film consisting of skin layers composed of a resin composition containing the above-described thermoplastic resin and inorganic filler and a core layer composed of another resin composition, subjecting at least one outermost surface, which is surface of the skin layer, to an oxidation treatment, and then carrying out the washing treatment (B). After the washing treatment (B), a drying treatment may be carried out. The multilayered thermoplastic resin film having a core layer and skin layers can produce a multilayer laminated film by a co-extrusion method using a multilayer die using a feed block or a multi-manifold, an extrusion lamination method using a plurality of dies, and the like.

Examples of the stretching method when stretching the film include a longitudinal stretching method using the peripheral speed difference of a group of rolls, a transverse stretching method using a tenter oven, a sequential biaxial stretching method combining these, a rolling method, a simultaneous biaxial stretching method by a combination of a tenter oven and a pantograph, and a simultaneous biaxial stretching method by a combination of a tenter oven and a linear motor. Other simultaneous biaxial stretching methods can also be used such as extruding a molten resin in the form of a tube using a circular die connected to a screw extruder followed by air blowing (inflation molding).

If the thermoplastic resin has a multilayer structure, when stretching multiple layers, each layer may be stretched individually before lamination and then laminated, or the layers may be stretched together after being laminated. Further, a stretched layer may be stretched again after lamination.

In the case where the thermoplastic resin used is an amorphous resin, the stretching temperature when performing stretching is preferably within a range equal to or more than the glass transition point temperatures of the thermoplastic resins. Further, in the case where the thermoplastic resin is a crystalline resin, the stretching temperature is preferably within a range equal to or more than the glass transition point of the amorphous portion of the thermoplastic resin, and in a range equal to or less than the melting point of the crystal portion of the thermoplastic resin. Specifically, a temperature 2 to 60° C.; lower than the melting points of the thermoplastic resins is preferred.

The stretching speed of the thermoplastic resin film is not particularly limited but is preferably within the range of 20 to 350 m/min from the viewpoint of stable stretch-molding.

Further, the stretching ratio when the thermoplastic resin film is stretched can also be appropriately determined considering the properties of the thermoplastic resin used, and the like. For example, in the case where a thermoplastic resin film including a homopolymer of propylene or a copolymer thereof is stretched uniaxially, the stretching ratio is usually about 1.2 times or more, and preferably 2 times or more, and is usually 12 times or less, and preferably 10 times or less. The stretching ratio in the case of biaxial stretching is usually 1.5 times or more, and preferably 10 times or more, and is usually 60 times or less, and preferably 50 times or less, in terms of area stretching ratio.

In the case where a thermoplastic resin film including a polyester-based resin is stretched uniaxially, the stretching ratio is usually 1.2 times or more, and preferably 2 times or more, and is usually 10 times or less, and preferably 5 times or less. The stretching ratio in the case of biaxial stretching is usually 1.5 times or more, and preferably 4 times or more, and is usually 20 times or less, and preferably 12 times or less, in terms of area stretching ratio.

Within the above-described range of the stretching ratio, the target porosity is obtained, and opacity tends to be improved. Further, the thermoplastic resin film is less likely to fracture, and stable stretch-molding tends to be achieved.

### <Oxidation Treatment>

An oxidation treatment can be carried out on one surface or on both surfaces of the thermoplastic resin film. When the inorganic filler-containing layer is laminated on the core layer as a skin layer, the oxidation treatment is carried out on the surface of the skin layer. In the present invention, an atmospheric oxidation treatment is performed, that is, in air under atmospheric pressure.

The oxidation treatment is not particularly limited as long as the surface of the object to be treated can be oxidized, and a known oxidation treatment can be used. Specific examples of the oxidation treatment include a dielectric barrier discharge treatment, a flame treatment, and an ozone treatment. Among them, a dielectric barrier discharge is preferred as the film treatment method because a high treatment effect is obtained and there is little damage to the substrate.

The term dielectric barrier discharge refers to the discharge that is generated when at least one of a pair of parallel plate electrodes having a certain gap is covered with an insulator (dielectric) and a high-voltage AC voltage is applied between the electrodes.

This discharge causes a phenomenon in which the gas that is normally present in a space in an insulated state is ionized. When this ionized gas is caused to act on a substance, the surface receives energy, causing the surface energy to increase and the surface to become activated. For example, when acting on a plastic or the like, polar groups are generated on the surface, improving wettability and adhesion. In addition, dielectric barrier discharge may sometimes be referred to as “atmospheric pressure plasma”, “corona discharge”, and the like.

The voltage application means is usually configured using a high-frequency transmitter that generates an AC voltage of a predetermined frequency f and a high-voltage transformer that boosts the magnitude of the AC voltage output from the high frequency transmitter to a predetermined voltage. As the high-frequency transmitter, for example, a high frequency power supply (CT-0212) manufactured by Kasuga Denki, Inc. can be used. As the high-voltage transformer, for example, a transformer (CT-T02W) manufactured by Kasuga Denki, Inc. can be used.

The frequency f of the AC voltage output from the high-frequency transmitter is preferably in the range of 10 to 200 kHz. The AC frequency range of 10 Hz or more is preferred because uniform discharge tends to occur (local discharge concentration is unlikely to occur). On the other hand, in the frequency range of 200 kHz or less, a low-resistance discharge channel due to residual ions remaining at a specific area, which is generated by the discharge, is less likely to be formed. Further, such a range is also preferred in terms of safety as well as the fact that it is easier to avoid overheating caused by a large current flow as a result of the discharge becoming locally concentrated and preventing uniform treatment. In this case, the waveform of the AC voltage output from the high frequency transmitter is not particularly limited as long as the frequency is in the above-described range of 10 to 200 kHz, and the waveform may be a sine wave or a square wave (including a pulse-shaped waveform).

For example, when performing the dielectric barrier discharge treatment, the discharge amount is preferably 600 J/m² (10 W·min/m²) or more, and more preferably 1,200 J/m² (20 W·min/m²) or more. Further, the discharge amount is preferably 12,000 J/m² (200 W·min/m²₎ or less, and more preferably 10,800 J/m² (180 W·min/m²) or less.

The discharge amount when a flame treatment is performed is preferably 8,000 J/m² or more, and more preferably 20,000 J/m² or more. Further, the discharge amount is preferably 200,000 J/m² or less, and more preferably 100,000 J/m² or less.

### <Washing Treatment (B)>

The washing treatment (B) is carried out on the surface that has been subjected to the oxidation treatment. The washing solvent used for the washing treatment (B) is preferably water or an aqueous solution from the viewpoint of solubility of the low molecular weight acidic compound to be removed by the washing. For example, the washing treatment is carried out by a method such as dipping in water or an aqueous solution. In particular, water or an aqueous solution having a pH of 5 to 11 is preferably used for washing. Use of a neutral, weakly basic, or weakly acidic solvent is preferred for washing because an acid or a base does not remain on the porous resin film surface after the washing. Further, for pH adjustment, from the viewpoint that residues are less likely to be generated, carbonic acid or hydrogen peroxide is preferably used when the aqueous solution is acidic, and ammonia is preferably used when the aqueous solution is basic. For example, if a strong acid such as hydrochloric acid, nitric acid, or sulfuric acid is used to adjust the pH of the aqueous solution, those strong acids may react with the inorganic filler and generate an inorganic salt on the thermoplastic resin film surface. Further, the thermoplastic resin may be deteriorated due to those acids themselves remaining on the film surface.

As the method of bringing the water or aqueous solution into contact with the surface of the thermoplastic resin film, in addition to the above-mentioned method of dipping in the liquid, various methods may be applied, such as spraying or showering onto both sides or at least the surface subjected to the oxidation treatment, or passing over a sponge-like roll in which the liquid has been absorbed. Among these methods, in particular, a method of dipping in a liquid is preferred because the film surface can be maintained in a uniformly wettened state with the water or aqueous solution.

### <Drying Treatment>

After the washing treatment (B), a drying treatment may be performed. The drying treatment method is not particularly limited, and a known drying method such as hot air drying and infrared drying can be used.

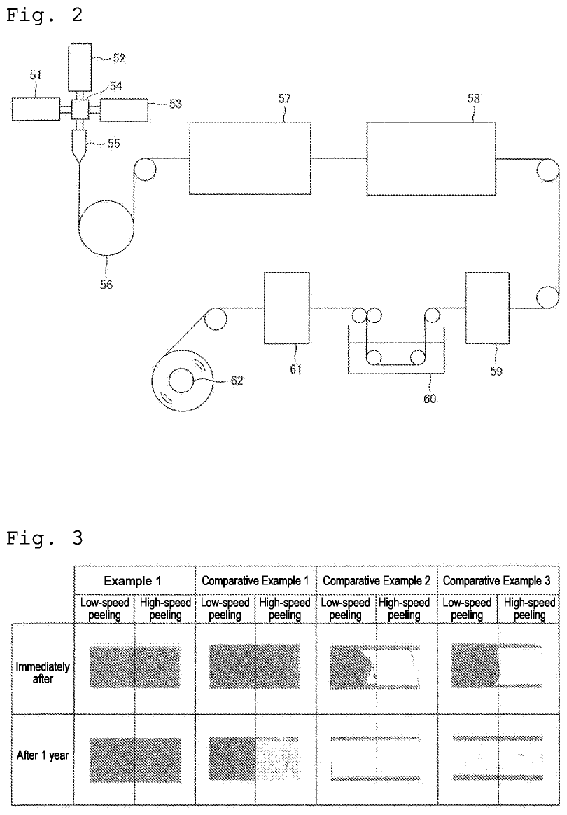

FIG. 2 illustrates an example of the steps for producing the thermoplastic resin film 1. These production steps are an example, and the steps may differ depending on the layer structure of the film, the number of stretching axes, and the like.

According to the example illustrated in FIG. 2, the thermoplastic resin film 1 having a three-layer structure can be produced using three extruders 51 to 53. For example, the resin composition of each layer is melt-kneaded and extruded from the three extruders 51 to 53, respectively, and laminated in order of a skin layer, a core layer, and a skin layer by an intermediate runner 54 and co-extruded from a T-die 55.

The co-extruded skin layer/core layer/skin layer laminated film is cooled by a cooling roll 56, stretched in the lengthwise direction (MD: machine direction) by a stretching apparatus 57, and then further stretched in a widthwise direction (TD: transverse direction) by a stretching apparatus 58. The surface of the stretched film is subjected to the oxidation treatment by an oxidation treatment apparatus 59, and then the washing treatment (B) is carried out by passing the surface subjected to the oxidation treatment through a water tank with a washing treatment apparatus 60. Next, the film is dried by a drying apparatus 61, and wound up by a winding roll 62.

### EXAMPLES

Hereinafter, the present invention will be further described in detail by way of examples, but the present invention is not limited to the following examples to the extent that the gist thereof is not exceeded. Unless stated otherwise, the words “parts”, “%”, and the like in the examples are described on a mass basis.

### (Resin Composition a)

A resin composition a composed of 80 parts by mass of a propylene homopolymer (manufactured by Japan Polypropylene Corporation, product name: Novatec PP FY-4, MFR (230° C., 2.16 kg load): 5 g/10 min, melting point: 165° C.) and 20 parts by mass of heavy calcium carbonate powder (manufactured by Bihoku Funka Kogyo Co., Ltd., product name: Softon 1800, average particle size 1.2 μm (measurement method: air permeation)) was prepared.

### (Resin Composition b)

A resin composition b composed of 55 parts by mass of a propylene homopolymer (manufactured by Japan Polypropylene Corporation, product name: Novatec PP FY-4, MFR (230° C., 2.16 kg load): 5 g/10 min, melting point: 165° C.) and 45 parts by mass of heavy calcium carbonate powder (manufactured by Bihoku Funka Kogyo Co., Ltd., product name: Softon 1800, average particle size 1.2 μm (measurement method: air permeation)) was prepared.

### (Resin Composition c)

A resin composition c composed of 100 parts by mass of a propylene homopolymer (manufactured by Japan Polypropylene Corporation, product name: Novatec PP FY-4, MFR (230° C., 2.16 kg load): 5 g/10 min, melting point: 165° C.) was prepared.

Table 1 shows the component of resin compositions a to c.

TABLE 1

| | | Resin composition | | |
|---|---|---|---|---|
| | | (parts by mass) | | |
| Material name | | a | b | c |
| Thermo- | Propylene homopolymer (product name: | 80 | 55 | 100 |
| plastic | Novatec PP FY-4, manufactured by | | | |
| resin | Japan Polypropylene Corporation, | | | |
| | MFR (230° C., 2.16 kg load): 5 | | | |
| | g/10 min, melting point: 165° C.) | | | |
| Inorganic | Heavy calcium carbonate powder | 20 | 45 | 0 |
| filler | (product name: Softon 1800, | | | |
| | manufactured by Bihoku Funka Kogyo | | | |
| | Co., Ltd., average particle size: 1.2 μm) | | | |

### Production Example 1

The resin composition a was melt-kneaded with an extruder set to 230° C., then fed to an extrusion die set to 250° C., extruded into a sheet shape, and cooled to 60° C. by a cooling apparatus to obtain a non-stretched sheet. The non-stretched sheet was reheated to 135° C., and then stretched by a factor of 5 times in the lengthwise direction utilizing the peripheral speed difference among the roll group. Next, the resin composition b was melt-kneaded with two extruders set to 250° C., then extruded into a sheet shape, and laminated onto either side of the sheet that had been stretched by a factor of 5 to obtain a laminated sheet having a three-layer structure.

The obtained laminated sheet was cooled to 60° C., reheated to about 150° C.; using a tenter oven, stretched by a factor of 8.5 times in the widthwise direction, and then again heat-treated by further heating to 160° C. After the heat treatment, the laminated sheet was cooled to 60° C., and selvages were slit up to obtain a thermoplastic resin film having a three-layer structure (resin composition of each layer: b/a/b, thickness of each layer: 10 μm/50 μm/10 μm, number of stretching axes of each layer: uniaxial/biaxial/uniaxial).

### Production Example 2

A thermoplastic resin film having a three-layer structure was obtained in the same manner as Production Example 1, except that the resin compositions a and b of Production Example 1 were each changed to resin composition c (resin composition of each layer: c/c/c, thickness of each layer: 10 μm/50 μm/10 μm, number of stretching axes of each layer: uniaxial/biaxial/uniaxial).

Table 2 shows the compositional makeup of the thermoplastic resin films of Production Examples 1 and 2.

TABLE 2

| | | | | Thickness | |
|---|---|---|---|---|---|
| | Resin composition | | | (thickness of | Number of |
| Thermoplastic | Skin | Core | Skin | each layer) | stretching |
| resin film | layer | layer | layer | (μm) | axes |
| Production | b | a | b | 70 (10/50/10) | uniaxial/biaxial/ |
| Example 1 | | | | | uniaxial |
| Production | c | c | c | 70 (10/50/10) | uniaxial/biaxial/ |
| Example 2 | | | | | uniaxial |

### Example 1

An oxidation treatment by dielectric barrier discharge treatment was carried out under the following conditions on one surface of thermoplastic resin film of Production Example 1.

### <Oxidation Treatment Conditions>

Method: Dielectric barrier discharge treatment
Environment: Atmospheric pressure in air

### Power: 100 (W·min/m²)

After the oxidation treatment, the washing treatment (B) was carried out by passing the thermoplastic resin film through a water tank filled with water. Next, the water was squeezed out with a squeeze roll, and moisture adhered to the surface was removed by performing a drying treatment in 70° C.; hot air to obtain the thermoplastic resin film of Example 1.

### Comparative Example 1

The thermoplastic resin film of Comparative Example 1 was obtained in the same manner as in Example 1, except that the washing treatment (B) and drying treatment carried out in Example 1 were not performed.

### Comparative Example 2

The thermoplastic resin film of Comparative Example 2 was obtained in the same manner as in Example 1, except that the thermoplastic resin film of Production Example 2 was used.

### Comparative Example 3

The thermoplastic resin film of Comparative Example 3 was obtained in the same manner as in Example 1, except that the thermoplastic resin film of Production Example 2 was used, and the washing treatment (B) and drying treatment carried out in Example 1 were not performed.

The thermoplastic resin films of each of the examples and comparative examples were evaluated as follows.

### (Porosity)

The porosity (%) of the skin layer was measured as follows.

An arbitrary portion of a thermoplastic film was cut off, and the portion was embedded and solidified in an epoxy resin. Then, the portion was cut perpendicularly to the face direction of the film using a microtome, and affixed to a sample observation stage such that the cut face became the face to be observed. Gold, gold-palladium, or the like was vapor-deposited on the face to be observed. The pores of the skin layer were observed with an electron microscope at an arbitrary magnification facilitating the observation (e.g., magnification of 500 times to 3000 times), and the observed region was captured as image data. The obtained image data was subjected to image processing by an image analyzer, the ratio (%) of the area of the pore portion of 10 or more arbitrary observed locations was calculated, and the calculated average value was taken as the porosity (%).

### (Surface Elastic Modulus)

The indentation modulus of the skin layer was measured using nanoindenter and taken as the surface elastic modulus.

The nanoindenter “ENT-2100” manufactured by Elionix Inc., was used for the measurement. On the side opposite to the measurement surface of the thermoplastic resin film, one drop of an instant adhesive (manufactured by Toagosei Co., Ltd., Aron Alpha®, professional impact resistance) was applied and the thermoplastic resin film was fixed to a dedicated sample fixing table via the instant adhesive. Measurement was carried out using the surface of the thermoplastic resin film that had been subjected to the oxidation treatment as the measurement surface. A triangular pyramid diamond indenter (Berkovich indenter) with a ridge angle of 115° was used in the measurement. Processing of the measured data was carried out using dedicated analysis software (version 6. 18) for the “ENT-2100” to measure the indentation modulus Ea_{IT} (MPa).

### <<Measurement Conditions>>

Measurement mode: Loading-unloading test
Maximum load: 100 μN
Holding time when maximum load is reached: 1 second
Loading speed, unloading speed: 10 μN/sec

### (Atom Concentration)

The oxygen atom concentration 0 (S0) atm % (number of oxygen atoms/(number of oxygen atoms+number of carbon atoms)) and the carbon atom concentration C atm % (number of carbon atoms/(oxygen atom number+number of carbon atoms)) on the surface of the thermoplastic resin film that had been subjected to the oxidation treatment were measured by XPS.

Then, the washing treatment (A) was carried out on the measurement surface by dipping the thermoplastic resin film in a container filled with distilled water for 30 seconds. After drying with hot air at 70° C., the oxygen atom concentration 0 (S1) atm % and carbon atom concentration C atm % of the surface after the washing treatment (A) were measured by XPS.

### <XPS Measurement Conditions>

Measurement of the oxygen atom concentrations S0 and S1 by XPS was carried out with the following apparatus under the following measurement conditions. The concentrations were determined from the ratio between values obtained by multiplying the relative sensitivity of each peak by the peak intensity area of the O1s and C1s, respectively.

Apparatus: K-Alpha, manufactured by Thermo Fisher
Excitation X-rays: Monochromatic Al Kα1, 2-wire
X-ray power: 200 W
X-ray width: 400 μm
Photoelectron take-off angle (tilt of the detector relative to the sample surface): 90°
(Adhesion with Ink)
<Evaluation Immediately after Production>

Ink was printed onto the surface that had been subjected to the oxidation treatment of the thermoplastic resin films of each of the examples and comparative examples immediately after production, and the adhesion of the printed ink was evaluated.

### <<Printing Method>>

Solid printing of an ink amount of 2.0 g/m² was carried out on the oxidation treatment surface side of the thermoplastic resin films obtained in the examples and comparative examples using a flexographic printing machine (manufactured by MT Tech Co., Ltd., product name: FC11B) and UV flexographic ink (manufactured by T&K TOKA Co., Ltd., product name: Flexo 500). Next, UV irradiation was carried out using a UV irradiation machine so that the irradiation intensity was 100 mJ/cm² to obtain samples for ink transition and ink adhesion evaluation.

### <<Adhesion Evaluation>>

After attaching 18-mm cellophane tape (manufactured by Nichiban Co., Ltd., product name: CT-18) on the printed image and adhering with a finger, low-speed peeling (peeling speed: 5 m/min) and high-speed peeling (peeling speed: 50 m/min) were performed at a peeling angle of 180 degrees. Evaluation was carried out based on the following criteria.

A: No ink peeling
B: Ink peeled and film surface is exposed
<Evaluation One Year after Production>

The thermoplastic resin films of each of the examples and comparative examples were stored in an ordinary temperature room for one year after being produced. The thermoplastic resin films after this one year were printed on in the manner described above in <<Printing method>>, and the adhesion of ink was evaluated by the above <<Adhesion evaluation>>.

Table 3 shows the evaluation results. Further, the samples after the adhesion evaluation test used in the examples and comparative examples are illustrated in FIG. 3. In each sample, as viewed from the front, the left half is the state after low-speed peeling, and the right half is the state after high-speed peeling.

TABLE 3

| | | | | | Comparative | Comparative | Comparative |
|---|---|---|---|---|---|---|---|
| | | | | Example 1 | Example 1 | Example 2 | Example 3 |
| Thermoplastic | Production Example No. | | | Production | Production | Production | Production |
| resin film | | | | Example 1 | Example 1 | Example 2 | Example 2 |
| | Skin layer | Filler content | | 45 | 0 | 0 | 0 |
| | | (% by mass) | | | | | |
| | | Porosity (%) | | 30 | 0 | 0 | 0 |
| | | Surface elastic modulus | | 300 | 300 | 3000 | 3000 |
| | | (MPa) | | | | | |
| Oxidation | Method | | | Dielectric banter | Dielectric barrier | Dielectric banter | Dielectric banter |
| treatment | | | | discharge | discharge | discharge | discharge |
| | Environment | | | Atmospheric- | Atmospheric- | Atmospheric- | Atmospheric- |
| | | | | pressure air | pressure air | pressure air | pressure air |
| | Power (W · min/m²) | | | 100 | 100 | 100 | 100 |
| | Post-treatment | | | Washing and | — | Washing and | — |
| | | | | drying | | drying | |
| Atom | Distilled water | O(S0) | [atm %] | 3.6 | 6.4 | 3.3 | 5.6 |
| concentration | before washing | C | [atm %] | 96.4 | 93.6 | 96.7 | 94.4 |
| | Distilled water | O(S1) | [atm %] | 3.4 | 3.5 | 3.2 | 3.3 |
| | after washing | C | [atm %] | 96.6 | 96.5 | 96.8 | 96.7 |

| | S1/S0 | | 0.94 | 0.55 | 0.97 | 0.59 |
|---|---|---|---|---|---|---|
| Adhesion | Immediately after | Low-speed peeling | A | A | A | A |
| with ink | | High-speed peeling | A | A | B | B |
| | After 1 year | Low-speed peeling | A | A | B | B |
| | | High-speed peeling | A | B | B | B |

As shown in Table 3, even for thermoplastic resin films of the same Production Example 1, the rate of change S1/S0 in oxygen atom concentration after the washing treatment (A) was small in Example 1, that is, in the range of 0.8 or more and 1.0 or less, whereas in Comparative Example 1 the rate of change S1/S0 was beyond this range and changed substantially. More specifically, there is a large amount of oxygen atom-containing foreign matter on the film surface. Therefore, the adhesion of the ink after 1 year is lower in Comparative Example 1, and the ink peeled off in the high-speed peeling test. Note that the oxygen atom concentration S0 before the washing treatment (A) on the surface that had been subjected to the oxidation treatment of Example 1 is lower than that of Comparative Example 1, but is 2.0% or more, and like Comparative Example 1, the adhesion of the ink immediately after production is sufficiently high.

In Comparative Examples 2 and 3, which used the thermoplastic resin film of Production Example 2, the surface of the skin layer did not contain an inorganic filler, and although adhesion was exhibited in the low-speed peeling test immediately after production, it can be seen that the adhesion over time is significantly inferior.

Further, FIG. 3 indicates that ink peeling over time observed in the thermoplastic resin film in Example 1 is much less than Comparative Examples 1 to 3.

This application claims priority from Japanese Patent Application No. 2019-141778, which is a Japanese patent application filed on Jul. 31, 2019, herein incorporated by reference in its entirety.

### REFERENCE SIGNS LIST

1 thermoplastic resin film
2 core layer
3, 4 skin layers
3a surface

1. A thermoplastic resin film comprising an inorganic filler, wherein
at least one surface of the thermoplastic resin film satisfies the following formula (1) and formula (2):
0.8≤S1/S0≤1.0 (1)
3.0≤S0 (2)
wherein S0 represents an oxygen atom concentration (atm %) before a washing treatment (A) is carried out, S1 represents the oxygen atom concentration (atm %) after the washing treatment (A) is carried out, the oxygen atom concentration is a ratio of the number of oxygen atoms to a sum of the number of oxygen atoms and the number of carbon atoms measured by XPS (X-ray photoelectron spectroscopy) (number of oxygen atoms/(number of oxygen atoms+number of carbon atoms)), and the washing treatment (A) is a washing treatment carried out using distilled water.

2. The thermoplastic resin film according to claim 1, wherein
a content of the inorganic filler in the thermoplastic resin film is 1 to 70% by mass.

3. The thermoplastic resin film according to claim 1, wherein
the inorganic filler has an average particle size of 0.1 to 10 μm.

4. The thermoplastic resin film according to claim 1, wherein
the thermoplastic resin film has a porosity of 3 to 60%.

5. The thermoplastic resin film according to claim 1, wherein
the thermoplastic resin film has a multilayer structure, at least an outermost layer on one side is an inorganic filler-containing layer containing a thermoplastic resin and an inorganic filler, and the surface of the outermost layer satisfies the formula (1) and the formula (2).

6. A method for producing a thermoplastic resin film, comprising:
subjecting at least one surface of a film containing a thermoplastic resin and an inorganic filler to an oxidation treatment; and
carrying out a washing treatment (B) on the surface subjected to the oxidation treatment,
wherein the surface on which the washing treatment (B) has been carried out satisfies the following formula (1) and formula (2):
0.8≤S1/S0≤1.0 (1)
3.0≤S0 (2)
wherein S0 represents an oxygen atom concentration (atm %) before a washing treatment (A) is carried out, S1 represents the oxygen atom concentration (atm %) after the washing treatment (A) is carried out, the oxygen atom concentration is a ratio of the number of oxygen atoms to a sum of the number of oxygen atoms and the number of carbon atoms measured by XPS (X-ray photoelectron spectroscopy) (number of oxygen atoms/(number of oxygen atoms+number of carbon atoms)), and the washing treatment (A) is a washing treatment carried out using distilled water.

7. The method for producing a thermoplastic resin film according to claim 6, wherein
the oxidation treatment is atmospheric dielectric barrier discharge treatment.

8. The method for producing a thermoplastic resin film according to claim 6, wherein
the washing treatment (B) includes a washing treatment carried out using water or an aqueous solution having a pH of 5 to 11.
